(19) United States
(12) Patent Application Publication
(10) Pub. No.: US 2026/0292325 A1
(43) Pub. Date: Sep. 24, 2026

(54) SYSTEMS AND METHODS THAT DETERMINE NON-RESTRICTED DATA OF IMAGES FOR COMMUNICATION OF THE NON-RESTRICTED DATA TO COMPUTING DEVICES

(71) Applicant: Lenovo Global Technology (United States) Inc., Morrisville, NC (US)

(72) Inventors: Philip Weinstein, Morrisville, NC (US); James G. McLean, Morrisville, NC (US)

(21) Appl. No.: 19/087,428

(22) Filed: Mar. 21, 2025

(51) Int. Cl. H04N 23/611; G06F 3/01; G06V 40/16; G06V 40/20

(52) U.S. Cl. CPC H04N 23/611; G06F 3/013; G06V 40/174; G06V 40/20

(57) ABSTRACT

Systems and methods that determine non-restricted data of images for communication of the non-restricted data to computing devices are disclosed. According to an aspect, a system includes an image capture device configured to capture one or more images of a subject. The system also includes a computing device comprising a data communication manager configured to receive data of the captured one or more images. The data communication manager is also configured to determine operation in a secure mode for restricting data communication. Further, the data communication manager is configured to analyze the received data of the captured one or more images to determine non-restricted data associated with the one or more images for communication to another computing device in response to the determination of operation in the secure mode. Further, the data communication manager is configured to communicate the non-restricted data to the other computing device.

### TECHNICAL FIELD

The presently disclosed subject matter relates generally to communication of image data. Particularly, the presently disclosed subject matter relates to systems and methods that determine non-restricted data of images for communication of the non-restricted data to computing devices.

### BACKGROUND

Increasingly, personal computers, smartphones, and various other computing devices incorporate cameras for capture of images and video. Oftentimes, these captured images and video are communicated to other computing devices in both business and personal settings. In addition to obvious human-to-human uses (such as video conferencing), these cameras have secondary human-to-machine applications such as presence detection, sentiment estimation, gaze detection and screen-dwell analysis, etc. These features may benefit users (e.g., by improving customer service or optimizing presentation of information); however, they require the user to allow a device camera to be attentive and not distracted during the interaction which has a social and psychological challenge. For example, many people feel a camera trained on them as an invasion of privacy that may give away more information than they are comfortable with. In addition, camera activation may be prohibited by some companies'security policies.

To address the aforementioned challenges with image and video communication, techniques have been developed to prevent unwanted communication of captured images or video. In many such cases, a user must either allow the camera to be used or forego the benefits of having it active. In an example, a visual indicator (e.g., LED) is used to inform the user when a camera is active. In this example, the user can override this, or, in extreme cases, manually cover the camera lens when they do not want to be seen. However, this precludes obtaining any value from the methods mentioned above.

In view of the foregoing, there is a continuing need for improved systems and techniques for managing and preventing unwanted communication of image data.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a system configured to determine non-restricted data of images for communication of the non-restricted data to a computing device in accordance with embodiments of the present disclosure;

FIG. 2 is a flow diagram of an example method for communication of the non-restricted data to a computing device in accordance with embodiments of the present disclosure;

FIG. 3 is a flow diagram of an example method for communication of the non-restricted data to a computing device and for prevention of communication of restricted data in accordance with embodiments of the present disclosure;

FIG. 4 is a flow diagram of an example method for communication of the non-restricted data to a computing device based on rules set at the computing device in accordance with embodiments of the present disclosure;

FIG. 5 is a block diagram of a computing device configured to use different devices to capture data of a subject based on operation in a secure mode in accordance with embodiments of the present disclosure; and

FIG. 6 is a flow diagram of an example method for controlling use of different devices to capture different types of data of a subject based on operation in a secure mode in accordance with embodiments of the present disclosure.

### SUMMARY

The presently disclosed subject matter relates to systems and methods that determine non-restricted data of images for communication of the non-restricted data to computing devices. According to an aspect, a system includes an image capture device configured to capture one or more images of a subject. The system also includes a computing device comprising a data communication manager configured to receive data of the captured one or more images. The data communication manager is also configured to determine operation in a secure mode for restricting data communication. Further, the data communication manager is configured to analyze the received data of the captured one or more images to determine non-restricted data associated with the one or more images for communication to another computing device in response to the determination of operation in the secure mode. Further, the data communication manager is configured to communicate the non-restricted data to the other computing device.

According to other aspects, a system includes a first device configured to capture a first type of data of a subject. The system also includes a second device configured to capture a second type of data of a subject. The first type of data is different than the second type of data. Further, the system includes a computing device comprising a data communication manager configured to use the first device for capturing data of the subject including the first type of data. The data communication manager is also configured to receive user selection to operate in a secure mode for restricting data communication. Further, the data communication manager is configured to determine operation in the secure mode. The data communication manager is also configured to use the second device for capturing data of the subject including the second type of data in response to the determination of operation in the secure mode. Further, the data communication manager is configured to communicate, to another computing device, the captured second type of data received from the second device.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As used herein, the term “memory” is generally a storage device of a computing device. Examples include, but are not limited to, read-only memory (ROM) and random access memory (RAM).

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini-or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

As referred to herein, the term “image capture device” is generally any device capable of capturing one or more images within its environment. Also, an image capture device may be referred to as a “camera”. The images can be, but are not limited to, still images, a video (e.g., a sequence of captured images), or the like. Example hardware components for an image capture device include, but are not limited to, one or more lenses, an image sensor, a processor, and a flash. The image sensor can convert input light into electrical signals for generating image data. Example image sensors include, but are not limited to, CMOS or CCD sensors. Software capabilities or features of an image capture device include, but are not limited to, face detection or tracking, HDR, image stabilization, auto-focus, background blurring, and the like. Example image data of a person can include, but is not limited to, presence data, gaze data, emotion data, facial expression data, gesture data, and the like. An image capture device may be, for example, an integrated part of a computing device (e.g., a smartphone or laptop computer with an integrated camera) or not integrated but in communication with a computing device (e.g., a camera having wire connection to a laptop or desktop computer).

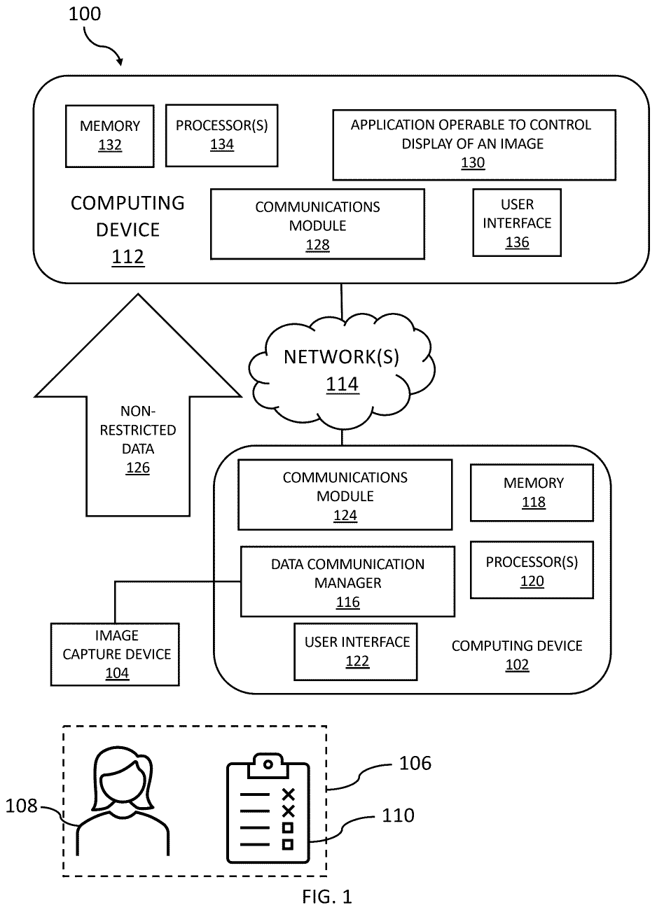

FIG. 1 illustrates a block diagram of a system 100 configured to determine non-restricted data of images for communication of the non-restricted data to a computing device in accordance with embodiments of the present disclosure. Referring to FIG. 1, the system 100 includes a computing device 102 operably connected to an image capture device 104. In an example, the image capture device 104 may be an integrated component of the computing device 102. In another example, the image capture device 104 may not be integrated with the computing device 102, but communicatively connected to the computing device 102 for communication of captured images to the computing device 102.

The image capture device 104 may be configured to capture one or more images (e.g., still images or video) within its field-of-view (FOV) 106. It is noted that FOV 106 is represented by broken lines, which correspond to borders of an image captured by the image capture device 104. In this example, the image within the FOV 106 includes a person 108 and a confidential document 110, although the image may include other objects. The image capture device 104 may capture a sequence of images, such as a video, of objects within the FOV 106. For example, the person 108 may be interacting with another person in a video conference. In this example, the captured video of the person 108 may be communicated to another computing device 112 via one or more communications networks 114 for display to another person engaged in the video conference. The confidential document 110 may contain information that is confidential and thus the person 108 does not want visible in the conference call. The confidential document 110 may be among many objects within the FOV 106, and thus inadvertently or accidentally placed in the FOV 106.

The computing device 102 includes a data communication manager 116 configured to receive data of images captured by the image capture device 104. The data communication manager 116 may suitably store the image data, such as within memory 118. The image data may also be associated with metadata, such as timestamp and location information (i.e., information that indicates the time and location of capture of the associated image).

In embodiments, the data communication manager 116 can determine operation of the computing device 102 in a secure mode. The data communication manager 116 can also analyze received data of captured images to determine non-restricted data associated with the captured images. This non-restricted data may be data permitted for communication to another computing device, such as computing device 112. Subsequent to determining or identifying the non-restricted data, the computing device may communicate this non-restricted data to another computing device. This feature of permitting communication of only non-restricted data may be enabled when it is determined that the computing device or one or more of its operations is in a secure mode.

Data communication manager 116 can include hardware, software, firmware, or combinations thereof. For example, functionalities of the data communication manager 116 disclosed herein can be implemented by memory 118 and one or more processors 120 running instructions stored in memory 118. In an example, all of the functionalities of the data communication manager 116 can be implemented by components of the computing device 102. In another example, a portion of the functionalities of the data communication manager 116 can be implemented by components of the computing device 102, while the other portion of the functionalities being implemented by one or more other computing devices.

In the example of image capture of person 108 and confidential document 110, an operator of the computing device 102 can direct the image capture device such that the person 108 and the confidential document 110 are within the FOV 106. Subsequently, the person 108 may interact with a user interface 122 to activate the image capture device 104 for capturing one or more images or video within the FOV 106. For example, the user interface 122 may touch an area of a touchscreen display of the computing device 102 for activating the image capture device 104.

Prior to or subsequent to activation of the image capture device 104, the computing device 102 may enter a secure mode with respect to communication of captured images, video, and/or associated data. For example, a user of the computing device 102 can interact with the user interface 122 to enable a secure mode for communication of captured images, video, and/or associated data. The data communication manager 116 can control the communication of only non-restricted data to other computing devices via a communications module 124 in response to a determination that the computing device 102 is operating in the secure mode. The data communication manager 116 can prevent the communication of restricted data, and can permit only the communication of non-restricted data. As a result, data that is captured by the image capture devices 104 and considered restricted can be maintained local to the computing device 102 without communication to another computing device.

Continuing the example of image capture of person 108 and confidential document 110, the data communication manager 116 can receive data of images captured within the FOV 106, including the person 108 and confidential document 110. The data communication manager 116 can analyze the received data of the captured images to determine non-restricted data associated with the captured images for communication to another computing device. For example, the data communication manager 116 can apply suitable image analysis techniques for determining that the captured images include the person 108. Continuing this example, the data communication manager 116 can determine that areas of the captured images other than the person 108 are to be restricted for communication. The data communication manager 116 can determine that areas of the captured images that include the person 108 are to be non-restricted for communication. The restriction of communication of data apart from the person 108 can assure that confidential information, such information that may be visible on the confidential document 110. In an example of videoconferencing, the data communication manager 116 can control and permit the communication of only image data captured of the person 108, while excluding or preventing communication of image data of the confidential document 110.

Computing device 112 can be a recipient of the non-restricted data of images captured by the image capture device 104. Continuing the example of capturing images within the FOV 106, the data communication manager 116 can control the communications module 124 to send to the computing device 112 non-restricted data 126 of an image of the person 108. The image data part from the person 108 can be omitted from communication to computing device 112, such as when in a video conference with another person using computing device 112. In an example, the data communication manager 116 may blur or otherwise obscure the image area apart from the person 108, and communicate the blurred or obscured image area to computing device 112.

Computing device 112 can receive the non-restricted image data 126 via its communications module 128. Further, computing device 112 can include an application 130 operable to control display of an image. For example, the application 130 may be a videoconferencing application or any other suitable application for displaying images or video. The application 130 can be implemented, for example, by memory 132 and one or more processors 134. A user of computing device 112 can interact with user interface 136 for controlling the application 130, and therefore display of the non-restricted image data 126.

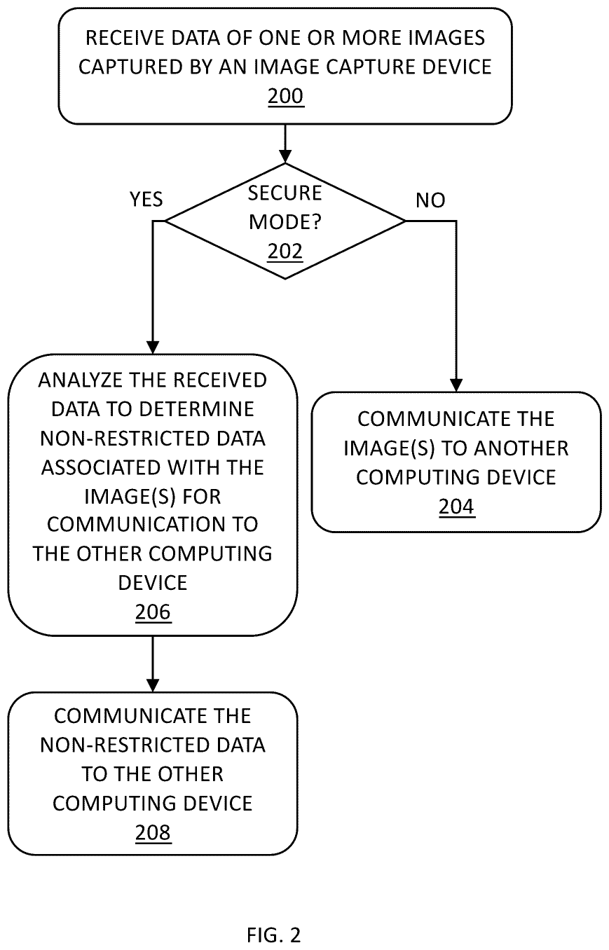

FIG. 2 illustrates a flow diagram of an example method for communication of the non-restricted data to a computing device in accordance with embodiments of the present disclosure. The method is described by example as being implemented by the system 100 shown in FIG. 1, although it should be recognized that the method may be implemented by any suitable system.

Referring to FIG. 2, the method includes receiving 200 data of one or more images captured by an image capture device. For example in FIG. 1, the image capture device 104 controlled by computing device 102 can capture one or more images within its FOV 106. The data communication manager can receive the image data and store the image data within memory 118.

The method of FIG. 2 includes determining 202 operation in a secure mode for restricting data communication. Continuing the aforementioned example, the data communication manager 116 can receive indication that the computing device 102 is operating in a secure mode. In response to determining that the operation is not in a secure mode, the method may communicate 204 the image(s) to another computing device. For example, the data communication manager 116 can permit the communication of the captured image(s) to computing device 112, or otherwise take no action to prevent the communication of the captured image(s) to computing device 112 in response to determining operation different than operation in the secure mode.

In response to determining that the operation is in a secure mode, the method includes analyzing 206 the received data to determine non-restricted data associated with the image(s) for communication to another computing device. Continuing the aforementioned example, non-restricted data can include, but is not limited to, a person's presence, gaze, emotion, facial expression, gestures, and the like. In the example of FIG. 1, the data communication manager 116 can analyze image data of the person 108 and determine the person's 108 presence, gaze, emotion, facial expression, gestures, or the like based on the analysis. The data communication manager 116 may apply suitable image analysis techniques for this determination. Such data may be identified as non-restricted data, and approved to send to computing device 112 in the secure mode.

The method of FIG. 2 includes communicating 208 the non-restricted data to the other computing device. Continuing the aforementioned example, the computing device 102 may communicate the approved, non-restricted data to computing device 112. For example, the data communication manager 116 can control or permit the communications module 124 to send the person's 106 presence data, gaze data, emotion data, facial expression data, gesture data, or the like to the computing device 102. This non-restricted data may be displayed via a display of the user interface 136.

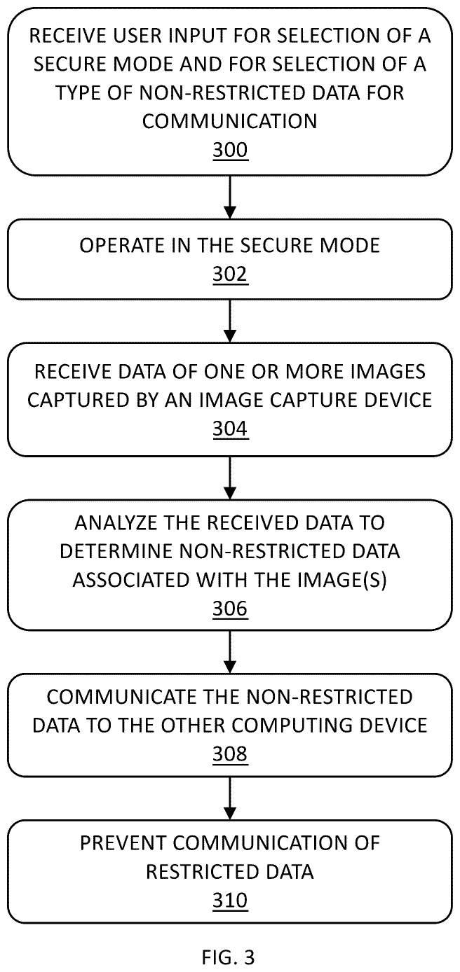

FIG. 3 illustrates a flow diagram of an example method for communication of the non-restricted data to a computing device and for prevention of communication of restricted data in accordance with embodiments of the present disclosure. The method is described by example as being implemented by the system 100 shown in FIG. 1, although it should be recognized that the method may be implemented by any suitable system.

Referring to FIG. 3, the method includes receiving 300 user input for selection of a secure mode and for selection of a type of non-restricted data for communication in the secure mode. For example, a user of computing device 102 can use the user interface 122 to select entry of a secure mode prior to capturing images or video. The user can also use the user interface 122 to select one or more types of non-restricted data for communication. Example non-restricted data that may be selected by the user includes, but is not limited to, person presence data, gaze data, emotion data, facial expression data, gesture data, and/or the like. The data communication manager 116 can receive the selections and initiate operation in the secure mode for only permitting communication of the selected type(s) of non-restricted data in the secure mode. Upon selection of the secure mode, the method includes operating 302 the computing device in the secure mode.

The method of FIG. 3 includes receiving 304 data of one or more images captured by an image capture device. Continuing the aforementioned examples, the image capture device 104 can capture images. The data communication manager 116 can receive the images and can analyze the images to generate and/or extract non-restricted data.

The method of FIG. 3 includes analyzing 306 the received data to determine non-restricted data associated with the image(s). Continuing the aforementioned example, some of the images may contain imagery that is non-restricted for communication, such as the face of the person 108. Further, the data communication manager 116 can analyze image data of the person 108 to generate and determine the person's 108 presence, gaze, emotion, facial expression, gestures, or the like based on the analysis. One or more of these types of data may be selected by the user as being non-restricted data. For example, the user may select the types of presence data and gesture data as being non-restricted for communication. In this example, the data communication manager 116 can determine the presence data and gesture data of the person 108 within the FOV 106 of the image capture device 104. Further in this example, the presence data and gesture data may be identified as non-restricted data for communication.

The method of FIG. 3 includes communicating 308 the non-restricted data to the other computing device. Continuing the aforementioned example, the computing device 102 may communicate the non-restricted data to computing device 112. Continuing the aforementioned example, the data communication manager 116 can control or permit the communications module 124 to send the presence data and gesture data of the person 106. This non-restricted data may be displayed via a display of the user interface 136.

The method of FIG. 3 includes preventing 310 communication of restricted data. Continuing the aforementioned example, the data communication manager 116 can prevent communication of any of the captured images within the FOV 106, or any types of data not selected by the user at step 300. The data communication manager 116 may only prevent communication of the images and/or the types of data not selected in response to a determination of operation in the secure mode.

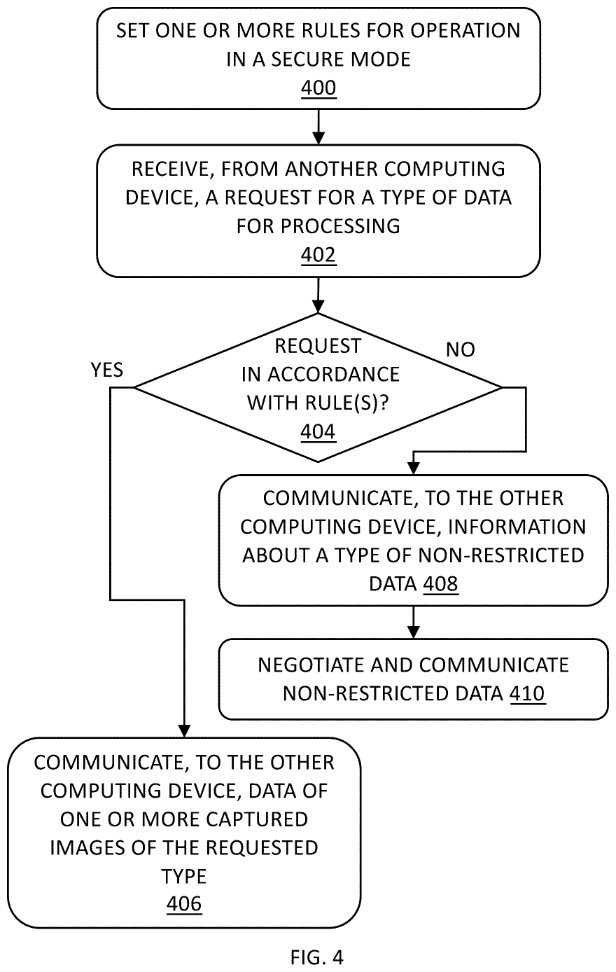

FIG. 4 illustrates a flow diagram of an example method for communication of the non-restricted data to a computing device based on rules set at the computing device in accordance with embodiments of the present disclosure. The method is described by example as being implemented by the system 100 shown in FIG. 1, although it should be recognized that the method may be implemented by any suitable system.

Referring to FIG. 4, the method includes setting 400 one or more rules for operation in a secure mode. For example, the user at computing device 102 can set one or more rules for operation of the computing device 102 in a secure mode for communication of non-restricted data to another computing device. The user interface 122 may be used for selecting types of non-restricted data that can be communicated, and/or for selecting types of restricted data that cannot be communicated. For example, a user may select to allow presence detection and gaze tracking information to be encoded and communicated. Also in this example, the user may select to not allow the communication of emotion or sentiment cues to be communicated based on facial expression. The selection of types of non-restricted data and/or types of restricted data can be stored as rules within memory 118.

The method of FIG. 4 includes receiving 402, from another computing device, a request for a type of data for processing. Continuing the aforementioned example, computing device 112 may be engaged in communication with computing device 102. For example, the application 130 of computing device 112 may request and be in communication to receive images, video, or related data from computing device 102. In an application, the application 130 may operate for displaying video or images captured by the image captured device 104, such as during video conferencing between computing devices 102 and 112. In this case, the application 130 may communicate a request to computing device 102 for video captured by image capture device 104.

The method of FIG. 4 includes determining 404 whether the requested type of data is in accordance with the rule(s) of the secure mode. Continuing the aforementioned example, the data communication manager 116 of computing device 102 can compare the requested type of data from computing device 112 to the types of non-restricted data set in the rules for communication. If the requested type of data matches one of the non-restricted types of data, the request may be deemed as being in accordance with the rules of the secure mode. In response to determining that the requested type of data is in accordance with the rule(s) of the secure mode, the method may include communicating 406, to the other computing device, data of one or more captured images of the requested type. For example, the data communication manager 116 can control the communication module 124 to send the requested type of data of the captured image(s) to computing device 112.

Turning again to step 404, the request may be deemed as not being in accordance with the rules of the secure mode in response to determining that the requested type of data does not match one of the non-restricted types of data. Alternatively or in addition for example, the request may be deemed as not being in accordance with the rules of the secure mode in response to determining that the requested type of data matches one of the restricted types of data. The method may proceed to step 408 in response to determining that the request is not in accordance with the rule(s).

At step 408 of FIG. 4, the method includes communicating 408, to the other computing device, information about a type of non-restricted data. Continuing the aforementioned example, the data communication manager 116 can communicate to computing device 112 a listing or other identification of types of non-restricted data in accordance with the rules. Subsequently, the method includes negotiating and communicating 410 non-restricted data. For example, computing device 102 and 112 can negotiate types of data for communication from computing device 102 to computing device 112. The data communication manager 116 can manage the negotiation and only permit agreement to communicate non-restricted types of data. Negotiations can include encoded queries for determining capabilities and user preferences of a user of computing device 112. In some examples, the computing device 112 can send user preference information to data communication manager 116 to check whether the user preference matches a type of non-restricted data type. The computing device 112 may actively request permission for the preference information to be sent to computing device 102.

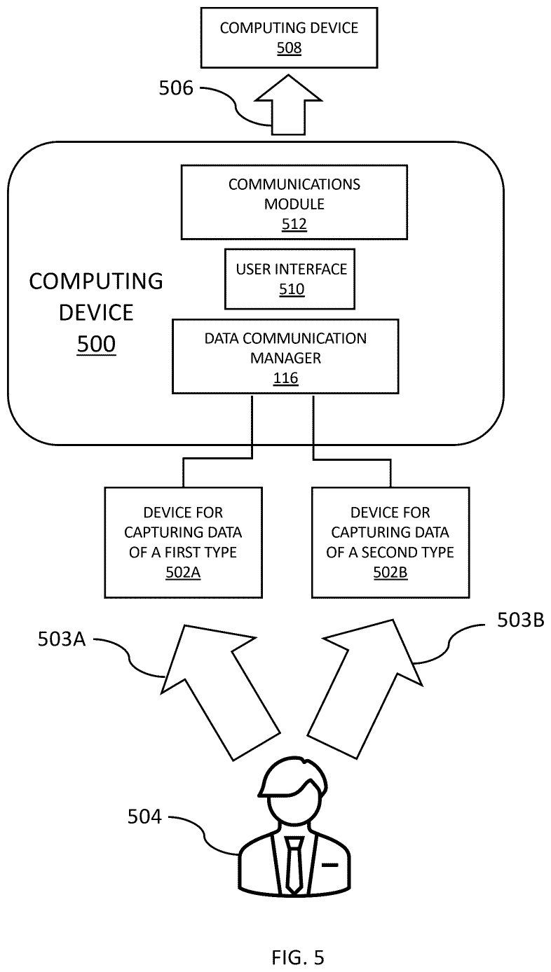

In accordance with embodiments, FIG. 5 illustrates a block diagram of a computing device 500 configured to use different devices 502A or 502B to capture data of a subject 504 based on operation in a secure mode. Referring to FIG. 5, the computing device 500 may include as integrated hardware or may be operatively connected to devices 502A and 502B configured to capture data of a first type 503A and a second type 503B, respectively. For example, device 502A may be a camera operable to capture visible light, while device 502B may be an infrared (IR) detector operable to capture infrared images (i.e., non-visible light). Devices 502A and 502B can be controlled to capture the data at the same time or individually at different times. The data communication manager 116 can control the communication of data 506 captured by devices 502A and 502B to another computing device 508. The data may be communication by use of communication module 512 via one or more networks (not shown).

With continuing reference to FIG. 5, computing device 500 can use a user interface 510 to receive user selection to operate in a secure mode for restricting data communication. For example, in a secure mode, the device 502B can be used for communication of its captured data to computing device 508, rather than use of device 502B for communication of its captured data to computing device 508. Apart for operation in the secure mode, the data communication manager 116 can permit communication of capture data from one or both of devices 502A and 502B.

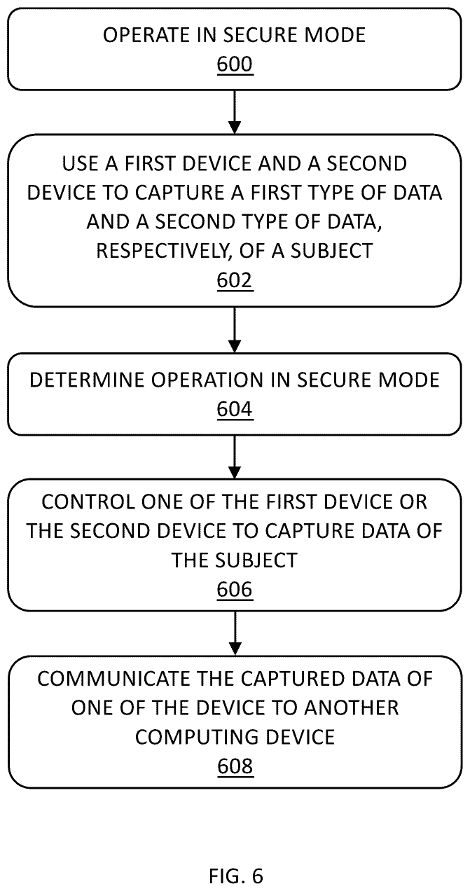

FIG. 6 illustrates a flow diagram of an example method for controlling use of different devices to capture different types of data of a subject based on operation in a secure mode in accordance with embodiments of the present disclosure. The method is described by example as being implemented by computing device 500 shown in FIG. 5, although it should be recognized that the method may be implemented by any suitable system.

Referring to FIG. 6, the method includes operating 600 in a secure mode. For example, computing device 500 shown in FIG. 5 can enter and operate in a secure mode. The user of computing device 500 can interact with the user interface 510 to enter a command for computing device 500 to enter and operate in the secure mode.

The method of FIG. 6 includes using 602 a first device and a second device to capture a first type of data and a second type of data, respectively, of a subject. Continuing the aforementioned example, the first device and the second device can capture their respective data types of subject 504. Subsequently, the captured data can be stored in memory (not shown) for control of communication to computing device 508. The data communications manager 116 can control the communication of the captured data of subject 504 to computing device 508.

The method of FIG. 6 can include determining 604 operation in the secure mode. In response to a determination of the computing device in the secure mode, the method includes controlling 606 one of the first device or the second device to capture data of the subject. Subsequently, the method includes communicating 608 the captured data of one of the devices to another computing device. Continuing the aforementioned example, the data communication manager 116 can determine that the computing device 102 is operating in the secure mode. In response to this determination of operating in the secure mode, the data communication manager 116 can permit only communication of one of the devices 502A or 502B. Communication of only data of the non-visible type may be permitted. In this instance, the data communication manager 116 can permit only communication of data from device 502B, which is IR detected data. The data communication manager 116 can also prevent communication of the data captured by device 502A. As a result, the data communication manager 116 communicates an alternative to visible light images when the computing device 500 is operating in a secure mode.

In accordance with embodiments, a user of computing device 508 can request a particular type of data for processing. For example, the computing device 508 can send to computing device 500 a request to send a request for visible light data. The data communication manager 116 can determine whether communication of the requested type of data is permitted in the secure mode. In response to determining that the requested type of data is not permitted, the data communication manager 116 can alternatively communicate to the computing device 508 other captured data, such as the captured data of non-visible light captured by device 502B.

In accordance with embodiments, a secure mode of operation can be made selectable, customizable, and/or visible to the user. For example, a “camera active” LED light may be used but display an alternate color, blink, or otherwise to inform the user that the secure mode is active. Alternatively, another indicator can be used that only signals whether or not the computing device is operating in the secure mode. The user may use buttons, software settings, or physical means (such as a shutter) to override this activity.

In embodiments, instructions for a computing device to operate in accordance with the present disclosure may be provided within a downloadable application, or sent by a remote entity itself as part of a negotiation as described herein. For example, consider a children's show-and-tell game that requires the player to make gestures. In this example, the code required to correctly interpret gestures from the local camera may be incorporated as a plug-in into the game application, or, in the case of a website, sent via HTML for local storage/usage.

In embodiments, control of a secure mode setting may be incorporated into a local/company security policy and monitored or enforced through a suitable technique. For example, a company that otherwise prohibits use of cameras on-site may allow the local-processing mode- or a limited set of capabilities enabled by this mode via its policy setting and monitoring software.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A system comprising:
an image capture device configured to capture one or more images of a subject; and
a computing device comprising a data communication manager configured to:
receive data of the captured one or more images;
determine operation in a secure mode for restricting data communication;
in response to the determination of operation in the secure mode:
analyze the received data of the captured one or more images to determine non-restricted data associated with the one or more images for communication to another computing device; and
communicate the non-restricted data to the other computing device.

2. The system of claim 1, wherein a type of the non-restricted data comprises person presence data, gaze data, emotion data, facial expression data, and/or gesture data.

3. The system of claim 1, further comprising a user interface configured to receive user input for selection of the secure mode, and
wherein the data communication manager is configured to:
determine selection of the secure mode; and
operate in the secure mode in response to determining selection of the secure mode.

4. The system of claim 1, wherein the data communication manager is configured to:
determine operation different than operation in the secure mode; and
communicate the one or more images to the other computing device in response to determining operation different than operation in the secure mode.

5. The system of claim 1, further comprising a user interface configured to receive user input for selection of a type of the non-restricted data for communication to the other computing device, and
wherein the data communication manager is configured to communicate, to the other computing device, the non-restricted data of only the selected type in response to the selection of the type.

6. The system of claim 1, wherein the selected type of the non-restricted data comprises person presence data, gaze data, emotion data, facial expression data, and/or gesture data.

7. The system of claim 1, wherein the data communication manager is configured to prevent communication of the one or more images in response to the determination of operation in the secure mode.

8. The system of claim 1, further comprising a user interface configured to indicate operation in the secure mode.

9. The system of claim 1, wherein the data communication manager is configured to:
receive, from the other computing device, a request for a type of data for processing;
determine whether the requested type of data is in accordance with a rule of the secure mode; and
communicate, to the other computing device, data of the one or more images of the requested type in response to determining that the requested type of data is in accordance with the rule of the secure mode.

10. The system of claim 9, wherein the computing device is configured to communicate, to the other computing device, information about a type of non-restricted data in accordance with the rule of the secure mode.

11. The system of claim 1, wherein the computing device is configured to receive information for implementing the data communication manager.

12. The system of claim 1, wherein the subject is a person.

13. A system comprising:
a first device configured to capture a first type of data of a subject;
a second device configured to capture a second type of data of a subject, wherein the first type of data is different than the second type of data;
a computing device comprising a data communication manager configured to:
use the first device for capturing data of the subject including the first type of data;
receive user selection to operate in a secure mode for restricting data communication;
determine operation in the secure mode;
in response to the determination of operation in the secure mode:
use the second device for capturing data of the subject including the second type of data; and
communicate, to another computing device, the captured second type of data received from the second device.

14. The system of claim 13, wherein the first type of data is visible light images of the subject, and
wherein the second type of data is data of the subject that is alternative to visible light images.

15. The system of claim 13, further comprising a user interface configured to receive user input for selection of the secure mode, and
wherein the data communication manager is configured to:
determine selection of the secure mode; and
operate in the secure mode in response to determining selection of the secure mode.

16. The system of claim 13, wherein the data communication manager is configured to:
determine operation different than operation in the secure mode; and
communicate, to the other computing device, the first type of data captured by the first device in response to determining operation different than operation in the secure mode.

17. The system of claim 13, wherein the data communication manager is configured to prevent communication of the first type of data captured by the first device in response to the determination of operation in the secure mode.

18. The system of claim 13, further comprising a user interface configured to indicate operation in the secure mode.

19. The system of claim 13, wherein the data communication manager is configured to:
receive, from the other computing device, a request for a type of data for processing;
determine whether the requested type of data is the same as the first type of data; and
communicate, to the other computing device, the captured second type of data received from the second device in response to the operation in the secure mode.

20. A method comprising:
receiving data of one or more images captured by an image capture device;
determining operation in a secure mode for restricting data communication; and
in response to the determination of operation in the secure mode:
analyzing the received data of the captured one or more images to determine non-restricted data associated with the one or more images for communication to another computing device; and
communicating the non-restricted data to the other computing device.
